(19) United States
(12) Patent Application Publication
(10) Pub. No.: US 2007/0235448 A1
(43) Pub. Date: Oct. 11, 2007

(54) Apparatus for microwave-assisted specimen preparation

(75) Inventors: Reinhard Lihl, Vienna (AT); Paul Wurzinger, Deutsch-Wagram (AT); Christian Peinhopf, Graz-Webling (AT); Peter Kettisch, Graz-Webling (AT)

Correspondence Address: SIMPSON & SIMPSON, PLLC, 5555 MAIN STREET, WILLIAMSVILLE, NY, 14221-5406, US

(73) Assignee: Leica Mikrosysteme GmbH, Vienna (AT)

(21) Appl. No.: 11/729,122

(22) Filed: Mar. 28, 2007

(30) Foreign Application Priority Data
Mar. 29, 2006 (AT) A 540/2006

(51) Int. Cl. H05B 6/70

(52) U.S. Cl. 219/697

(57) ABSTRACT

In an apparatus for microwave-assisted preparation of specimens, the microwave chamber for reception of specimens to be processed is embodied as a waveguide (3), in particular as a monomode waveguide, and is equipped with at least one opening (3a) for introduction of the at least one specimen (11) into the waveguide. A cooling circuit comprises a cooling means (8) adapted to cool the fluid (12), which fluid surrounds the at least one specimen and is separated from the cooling liquid of the cooling circuit, in the region of the at least one specimen (11) inside the waveguide. The opening (3a) can be sealed in microwave-tight fashion, by means of a closure means (7), during operation of the apparatus.

### CROSS REFERENCE TO RELATED APPLICATIONS

This application claims priority of Austrian Patent Application A 540/2006, filed Mar. 29, 2006, which application is incorporated by reference herein.

### FIELD OF THE INVENTION

The invention relates to an apparatus for microwave-assisted preparation of specimens, in particular specimens of a biological nature, having at least one microwave generator, a microwave chamber for reception of at least one specimen to be processed, and a cooling circuit for cooling a fluid, which fluid surrounds the at least one specimen and is separated from the cooling liquid of the cooling circuit.

### BACKGROUND OF THE INVENTION

Microwave-assisted preparation devices of the aforesaid kind are known from DE 103 13 870 A1 and U.S. Pat. No. 6,875,583. The preparation of biological specimens is performed, for example, for the purpose of an electron-microscope examination. In this context, microwaves are used to stimulate and accelerate the fixing, substituting, infiltrating, and polymerizing processes. The overall time for the preparation processes can thereby be greatly reduced (Wendt et al., J. Microscopy, 214 (2004) pp. 80-88).

U.S. Pat. No. 6,875,583 discloses a device for rapid microwave-assisted fixing of tissue. Biological samples are positioned, in a formalin solution serving as fixing agent, in the microwave field of a multimode chamber. The microwave power is controllable. The temperature is controlled by cooling and pump-circulating the fixing solution outside the microwave field.

The pump-circulating and cooling of reagents during the processing of biological samples has the disadvantage that reagent replacement entails considerable complexity. Valves, pumps, and reservoir and waste containers must be provided. In U.S. Pat. No. 6,875,583 the use of the disclosed invention is therefore limited to one specific process step. A relatively high consumption of chemicals is also associated with an arrangement of this kind, since not only the process vessel but additionally the entire cooling circuit must be filled. The replacement and replenishment of reagents must also encompass washing steps for the cooling circuit.

Multimode microwave chambers, i.e., chambers such as a household microwave oven having relatively large chamber dimensions, exhibit large local inhomogeneities in microwave intensity (so-called “hot spots” and “cold spots”). Apparatuses for homogenizing the microwave field are therefore necessary in order to create defined and reproducible process conditions.

U.S. Pat. No. 6,329,645 discloses a device for preventing so-called “hot spots” in a multimode microwave oven. This is a flat, closed trough that is filled with a polar (i.e., microwave-absorbing) liquid. The interaction of the liquid with the microwave field results in a homogenization of the microwave field. This liquid additionally circulates through a circuit that contains, outside the microwave device, an apparatus for cooling the liquid. The temperature of the liquid can be monitored and controlled in this fashion. The environmental conditions of biological samples that are being processed in the microwave field are thereby stabilized. This apparatus could also be used to cool process vessels. The bottom of the process vessel and the cover of the cooling apparatus are, however, located between the cooling medium and the process liquid that is to be cooled; this greatly limits heat transfer between the two media. Cooling is therefore very ineffective in this geometrical arrangement.

U.S. Pat. Nos. 6,753,517, 6,917,023, and 6,744,024 disclose devices for microwave-assisted chemical synthesis. The reagents are located in a microwave-transparent reaction vessel that is positioned inside the internal cavity of a microwave resonator shaped like a cylindrical ring; the specimen is not, however, located in the actual waveguide that annularly surrounds the cavity. Apertures in the inner waveguide wall cause microwave radiation to travel to the reaction vessel. A comparatively homogeneous distribution of the microwave radiation field over the region in which the reaction takes place is thereby achieved, but this arrangement requires additional complex sealing of the microwave radiation toward the outside. The temperature in the reaction vessel is monitored by a sensor, and is controlled by regulating the microwave power or by cooling the outer shell of the reaction container with the aid of a flow of gas or liquid.

Better cooling is achieved in these devices because cooling medium flows directly around the outer wall of the vessel. When reagents need to be exchanged in this arrangement, however, either they must be pumped or pipetted into a stationary vessel, or the vessel must be removed from the cooling medium and replaced with another that is in turn immersed in the cooling medium. Both approaches are associated with relatively high technical complexity or with complex manipulations by the user.

Unexamined Application DE 103 13 870 A1 discloses the use of a non-polar liquid (i.e., one that can be heated very little or not at all by microwaves) to condense liquid vapors in a microwave field. The cooling medium is cooled in a cooling circuit and receives heat almost exclusively from the vapors to be condensed, which are directed to the cooling circuit via a conduit. Cooling is therefore indirect, and the cooling power at the location of the specimen results substantially from the boiling/evaporation of the gases or vapors occurring in the context of the microwave reaction.

### SUMMARY OF THE INVENTION

The object of the present invention is to make available a device with which the specimens can be processed in a homogeneous and reproducible microwave field. At the same time, the temperature of the samples during the process steps is intended to be capable of being adjusted and monitored during the process steps, largely independently of the microwave power. The invention is furthermore intended to allow automation of the entire preparation process.

This object is achieved by an apparatus of the kind cited initially in which, according to the present invention, the microwave chamber is embodied as a waveguide that comprises at least one opening for introduction of the at least one specimen into the waveguide, and the cooling circuit comprises a cooling means adapted to cool the fluid in the region of the at least one specimen inside the waveguide.

With the manner according to the present invention of achieving the object, in contrast to previously known devices, the specimens are located in a waveguide for microwaves, thus ensuring that the microwave radiation is highly homogeneous and reproducible, while the direct cooling of the region surrounding the specimen results in efficient cooling that can be better monitored.

In a preferred embodiment, the waveguide is embodied as a monomode waveguide, which additionally improves homogeneity and reproducibility.

Advantageously, at least one closure means is provided with which the at least one opening is sealable in microwave-tight fashion during operation of the apparatus. Not only does this prevent contamination of the environment with microwave radiation, but the homogeneity and stability of the microwave field in the wave guide is also greatly improved. The closure means can be joined to a holding apparatus for the specimen(s), thereby resulting in unambiguous positioning of the specimens within the waveguide and at the same time preventing the waveguide from inadvertently remaining unclosed.

In a preferred embodiment of the invention, the waveguide comprises oppositely located openings, a second opening for the introduction of a container of the fluid being set up with respect to a first opening of the aforesaid kind, i.e., for the introduction of at least one specimen by means of a holding apparatus. This facilitates loading of the apparatus, and moreover simplifies maintenance of and any repairs to these components. The second opening can be closed off, for example, with a microwave-tight closure. In an advantageous variant, in order to allow the passage of, for example, retaining elements for the reagent container which simplify positioning of the container and changing of the reagent fluid, an attenuator tube that prevents the emergence of microwave radiation can be provided on this opening. Usefully, the opening for introduction of the specimen(s) can be arranged on the upper side of the waveguide, and the opening for introduction of the fluid container on the lower side of the waveguide.

It is favorable if the fluid surrounding the specimen(s) not only provides for temperature adjustment of the specimen(s) via the cooling part, but is also a reagent for processing of the specimen(s).

In order to achieve targeted temperature adjustment at the location of the specimen(s), a temperature sensor for measuring the temperature of the fluid in the region of the at least one specimen, and a control device, connected to the temperature sensor, for controlling the supplied microwave power as a function of the measured temperature, are particularly appropriate. The control device can be set up to control the injected microwave power by regulating the magnetron power or by pulsing the microwave radiation on a suitable duty cycle. The control device can furthermore be set up to control the cooling power furnished via the cooling circuit and cooling means. Adjustment and stabilization of the processing temperature can be substantially improved by these actions.

### BRIEF DESCRIPTION OF THE DRAWINGS

Further examples of possible configurations of the disclosed device, as well as preferred embodiments, are described below with reference to the appended Figures, in which:

FIG. 1 schematically depicts a first embodiment of the invention in cross section;

FIG. 2 shows a second embodiment of the invention; and,

FIG. 3 shows a third embodiment of the invention.

The embodiments shown here are to be understood as examples, and do not represent a limitation of the invention to the embodiments presented. According to the invention, the reagents are cooled via a cooling apparatus simultaneously with microwave irradiation. The temperature is measured with a sensor, and the measured value is coupled into an electronic regulating system as a control signal. The magnetron's emission can be regulated electronically. The magnetron power, microwave radiation pulses, and cooling power are available as control parameters. It is thus possible to set and hold a process temperature during the microwave process. This prevents degradation of the specimens due to excessively high process temperatures.

### DETAILED DESCRIPTION OF THE INVENTION

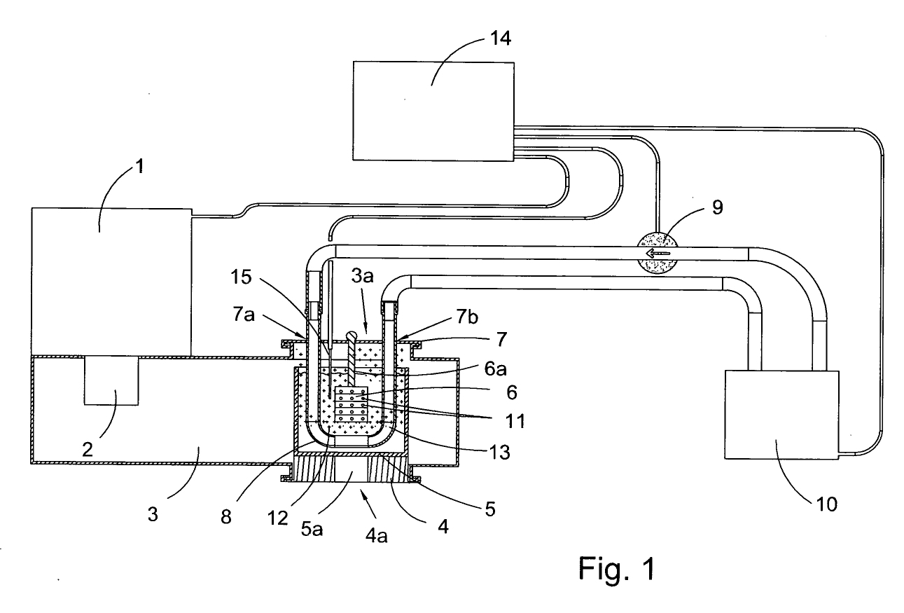

FIG. 1 shows a first preferred exemplifying embodiment of the invention: an apparatus for the preparation of biological sections, having a process chamber that permits introduction of the specimens from above. Microwave radiation is coupled by a magnetron 1, via its antenna 2, into a waveguide 3 that is embodied as a monomode waveguide for microwave radiation. The waveguide is a tube, for example of rectangular cross section, that is sealed at both ends, and is dimensioned so that a largely homogeneous and constant microwave field is established at the location of specimens 11 to be processed. The specimens can be introduced through the upper side of the waveguide; vessels having the reagents, on the other hand, are introduced into the chamber from below, and in this fashion are exchangeable during the process, thus enabling process automation. The openings are each configured in such a way that microwave emergence is prevented.

Specimens 11 are received in at least one holding apparatus 6, e.g., a basket, and can be introduced and removed through an opening 3a located in the waveguide on the upper side. In the operating state, the opening is covered by a closure 7 that seals the chamber at the top and is embodied so that the emergence of microwave radiation is prevented. Holding apparatus 6 for specimens 11 is joined to closure 7 preferably via a (for example, rod-shaped) holding element 6a, and hangs from closure 7 into a vessel 5 made of microwave-transparent material. The vessel contains a reagent 12 that is used for processing of specimens 11. Vessel 5 is held in position from below by a second closure 4, and can be exchanged downward through lower opening 4a closed off by lower closure 4. Lower closure 4 is likewise embodied so that the emergence of microwave radiation is prevented.

In the embodiment shown, upper closure 7 also receives, in addition to the specimen carriers, at least one cooling tube 8 that is part of a cooling circuit having a pump 9 and secondary heat exchanger 10. In the exemplifying embodiment shown, cooling tube 8 is guided through openings 7a, 7b in closure 7 and extends between specimen carrier 6 and the wall of vessel 5. A liquid 13 is pumped by means of pump 9 through the cooling tube as a cooling liquid to cool reagent 12 during the microwave process, and is cooled in secondary heat exchanger 10. Liquid 13 is preferably a non-polar liquid that is not (or almost not) heated by microwave radiation, e.g., silicone oil, or a liquid having a high heat capacity, e.g., water. Cooling tube 8 is nonmetallic and is made of a material that is not heated by microwaves. It is embodied so as to guarantee good heat exchange between liquid 13 and reagent 12. It is preferably embodied from thin-walled glass or ceramic, e.g., aluminum oxide. Any circulation of reagent 12, in particular in a separate circuit, is therefore superfluous in this embodiment. When plastic is used as the tube material of cooling tube 8, the wall area must be enlarged by corrugation or other suitable geometric measures in order to guarantee good thermal contact between the cooling and process liquids despite the relatively low thermal conductivity of the wall material. Cooling homogeneity and overall cooling performance can be improved if, instead of the one cooling tube 8, two or more cooling tubes, arranged in an annulus around specimen holders 6, are operated concurrently. The use of a cooling loop, as known from chemical liquid coolers, would also be conceivable.

Depending on the desired process temperatures and the cooling power necessary therefor, secondary heat exchanger 10 can dissipate heat to a large-volume reservoir tank or else to an active cooling element, e.g., a Peltier element or a compressor refrigerator. A Peltier element whose cooling power is adapted to the cooling power of the cooling tube is preferred.

The temperature of liquid 13 is measured using a temperature sensor 15. This temperature sensor is depicted as an immersion sensor (e.g., gas thermometer or infrared thermometer having a fiber optic cable). It can, however, also be embodied as a non-contact infrared sensor that is mounted above or alongside the vessel and measures the thermal radiation emitted from the liquid or the vessel wall. The measured temperature signal is transmitted to an electronic regulating system 14. Electronic regulating system 14 can regulate the magnetron power or, if the power is permanently set, can drive the magnetron in pulse mode and thereby regulate the microwave power. Regulation of the cooling power can additionally be provided by electronic regulating system 14, the delivery capacity of pump 9 and (when a Peltier element or cooling compressor is used) the temperature in secondary heat exchanger 10 being available as control parameters.

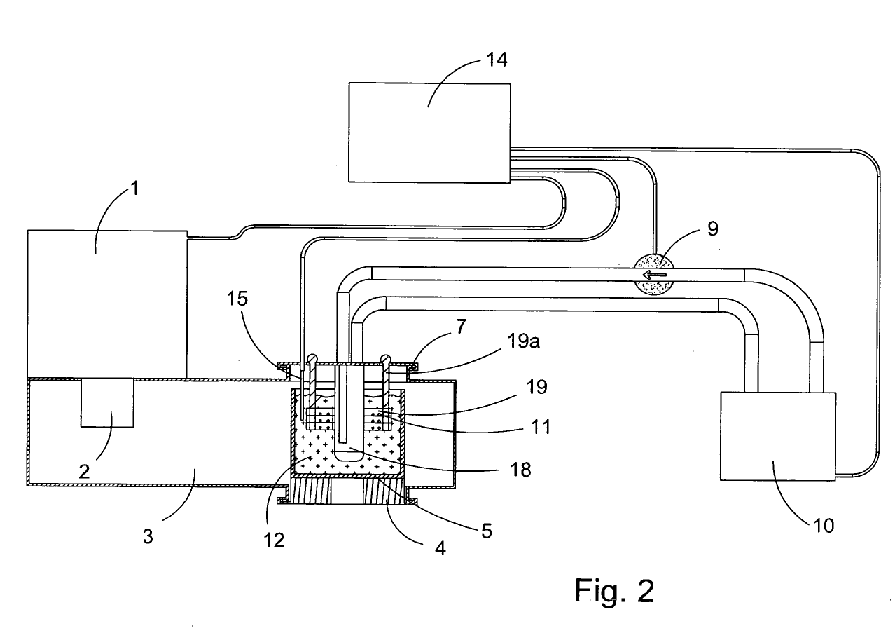

FIG. 2 shows another preferred embodiment of the invention. Here a cooling tube 18 is arranged substantially centrally along the axis of vessel 5. Holding apparatus 19 for the at least one specimen 11 is now embodied annularly, and surrounds cooling tube 18. Holding apparatus 19 can be joined to cover 7 by way of attachment elements 19a as depicted in FIG. 2, or can be attached directly to cooling tube 18 by way of corresponding clamping elements. Cooling tube 18 can be embodied in a hairpin shape with the inflow and outflow lying next to one another, or in siphon fashion with the inflow and outflow surrounding one another. Temperature sensor 15 is now preferably arranged so that it senses the temperature at the side of the specimen retainers facing away from the cooling tube. Also particularly suitable for this is an infrared sensor that is directed from outside onto the side wall of vessel 5. Otherwise, the statements made with respect to the embodiment shown in FIG. 1 apply to this embodiment.

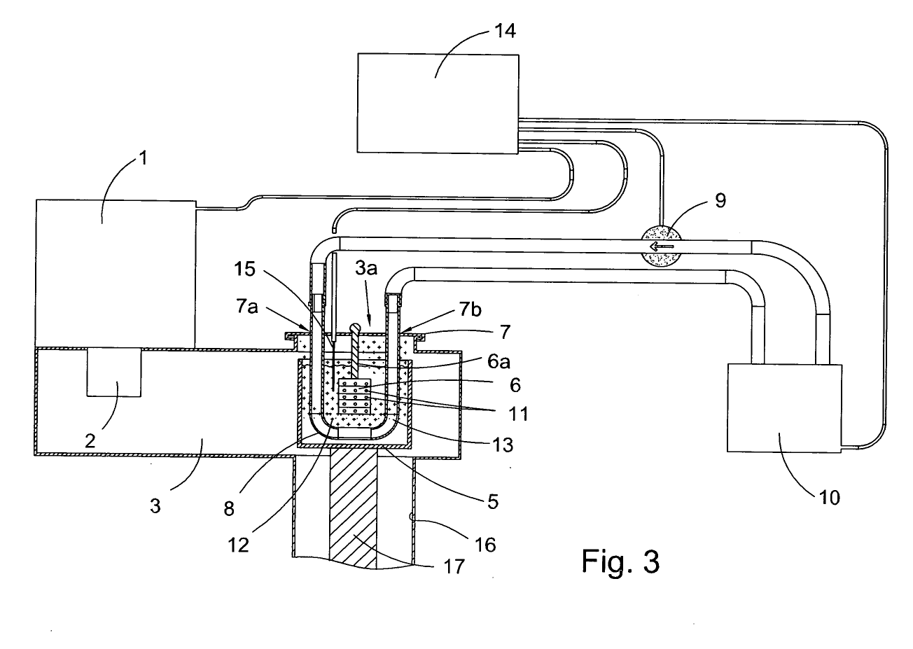

FIG. 3 shows a further preferred embodiment of the invention. Here the emergence of microwave radiation at the lower side of the microwave chamber is not prevented by a cover, but instead an attenuator tube 16 is provided on the lower, second opening 4a that is open at the bottom and shaped geometrically and is used so that the emergence of microwave radiation is effectively prevented. In this embodiment, vessel 5 having the reagent is held by a long column 17 that is held in position from outside. Otherwise, the statements made with respect to the embodiment shown in FIG. 1 apply to this embodiment. This embodiment is particularly suitable for automatic changing of the reaction liquids.

What we claim is:

1. An apparatus for microwave-assisted preparation of specimens, having at least one microwave generator, a microwave chamber for reception of at least one specimen to be processed, and a cooling circuit for cooling a fluid, which fluid surrounds the at least one specimen and is separated from the cooling liquid of the cooling circuit,
wherein the microwave chamber is embodied as a waveguide (3) that comprises at least one opening (3a) for introduction of the at least one specimen (11), and
the cooling circuit comprises a cooling means (8) adapted to cool the fluid (12) in the region of the at least one specimen (11) inside the waveguide.

2. The apparatus according to claim 1, wherein the waveguide is embodied as a monomode waveguide (3).

3. The apparatus according to claim 1, wherein at least one closure means (7) is provided with which the at least one opening (3a) is sealable in microwave-tight fashion during operation of the apparatus.

4. The apparatus according to claim 3, wherein the closure means (7) is joined to a holding apparatus (6) for the specimen(s) (11).

5. The apparatus according to claim 1, wherein the waveguide comprises oppositely located openings (3a, 4a), a second opening (4a) for the introduction of a container (5) of the fluid being set up with respect to a first opening (3a) for the introduction of at least one specimen (11) by means of a holding apparatus (6).

6. The apparatus according to claim 5, wherein the opening (3a) for introduction of the specimen(s) is arranged on the upper side of the waveguide (3), and the opening (4a) for introduction of the fluid container (5) on the lower side of the waveguide.

7. The apparatus according to claim 5, wherein an attenuator tube (16) that prevents the emergence of microwave radiation is provided on the second opening (4a).

8. The apparatus according to claim 1, characterized by a temperature sensor (15) for measuring the temperature of the fluid (12) in the region of the at least one specimen, and by a control device (14), connected to the temperature sensor, for controlling the injected microwave power as a function of the measured temperature.

9. The apparatus according to claim 8, wherein the control device (14) is set up to control the injected microwave power by regulating the magnetron power.

10. The apparatus according to claim 8, wherein the control device (14) is set up to control the injected microwave power by pulsing the microwave radiation on a suitable duty cycle.

11. The apparatus according to claim 8, wherein the control device (14) is set up to control the cooling power furnished via the cooling circuit and cooling means (8).

12. The apparatus according to claim 1, wherein the fluid (12) surrounding the specimen(s) is a reagent for processing of the specimen(s) (11).
